(19) United States
(12) Patent Application Publication
(10) Pub. No.: US 2020/0053322 A1
(43) Pub. Date: Feb. 13, 2020

(54) Vehicle Operator Monitoring System to Record, Store, and Distribute Video/Audio Sequences of Unsafe Vehicle Operators

(71) Applicant: Miguel Fernandez, New Smyrna Beach, FL (US)

(72) Inventor: Miguel Fernandez, New Smyrna Beach, FL (US)

(21) Appl. No.: 16/101,492

(22) Filed: Aug. 12, 2018

(51) Int. Cl. H04N 7/18; H04N 5/247

(52) U.S. Cl. CPC H04N 7/181; H04W 84/12; H04N 5/247

(57) ABSTRACT

This invention permits a vehicle operator to display, record, store, and distribute video/audio sequences of the real-time unsafe, careless, or reckless driving patterns of an adjacent vehicle operator within the visual range of the system-equipped vehicle. The system comprises of two (2) mounted (forward facing and rear facing), Wi-Fi capable video cameras that work in conjunction with a mobile telephone application. Contributing to the deterrence of unsafe driving, the system-equipped vehicle operator will have the option to use the mobile telephone application to also distribute the video/audio sequences of an unsafe vehicle operator to traffic law enforcement.

### BACKGROUND OF THE INVENTION

### 1. Field of the Invention

This invention relates generally to video imaging systems for vehicles and, more particularly, to a vehicle operator monitoring system comprised of two (2) WI-FI capable, normal/infrared cameras, affixed to the forward and rear facing interior of a vehicle, and a mobile telephone application which enables the display, recording, storage, and distribution of video/audio sequences.

Each year tens of thousands of safe vehicle operators are witness to, and as many are regrettably victims of unsafe vehicle operators sharing the same roads. Neither established traffic laws or vigilant law enforcement are sufficient to reduce the increasing frequency of aggressive, careless, or reckless vehicle operators. It is anticipated, however, that utilizing a conspicuous vehicle operator monitoring system to display, record, store, and distribute video/audio sequences of unsafe drivers will assist in mitigating the frequency of unsafe vehicle operators.

Preemptively curtailing unsafe vehicle operation is clearly desirable to the alternative, or manifestations of unsafe, careless, or reckless vehicle operation. Conceivably, as vehicle operators increasingly adopt usage of this invention countless other unequipped vehicle operators will be more vigilant, cautious, and respectful of those vehicles that have conspicuously installed the vehicle operator monitoring system. Consequently, potential aggressive escalations or other occurrences of unsafe, careless, or reckless vehicle operation could be avoided.

### 2. Description of the Prior Art

U.S. Pat. No. 6,421,080 discloses a digital surveillance system with pre-event recording. An image recording subsystem is connected to the cameras to receive generated video images, and store the received images in a temporary storage device having a storage capacity large enough to store video images generated over a predetermined period of time. The image recording subsystem is arranged to continuously record video images into the temporary storage device such as a cache memory, and in response to the occurrence of a triggering event, subsequently record the temporarily stored video images into a long-term storage device for later retrieval.

An imaging system with a vehicle camera has been disclosed in U.S. Pat. No. 7,965,336, incorporating a camera, which may be mounted at an exterior portion of a vehicle, providing an image of the exterior of the vehicle.

U.S. Pat. No. 6,459,988 presents methods and systems for detecting vehicle collision using a global positioning system (GPS). A GPS receiver is combined with wireless technology to automatically report an accident to a remotely located third party. A system uses the GPS signals to determine when an acceleration value exceeds the preset threshold, which is meant to be indicative of an accident having occurred.

One system incorporating a WI-FI reversing camera transmission mode, that incorporates a camera and vehicle navigation host computer that meets through wireless transmission data, is disclosed in U.S. Pat. No. 7,940,305. With this invention, a camera and display device is presented that captures and displays images of the surroundings of a motor vehicle.

U.S. Pat. No. 6,389,340 discusses cameras for automobiles that capture video images, both forward- and rear-looking, and for storing recorded images locally on a mass storage system. At the end of the vehicle service day, an operator can download information into a desktop computer system having specialized application software, permitting the images and other information to be played-back and analyzed with a highly integrated user display interface.

### DESCRIPTION OF THE DRAWINGS

FIGS. 1, 2, and 3 are perspective views illustrating the vehicle operator monitoring system, constructed in accordance with the present invention.

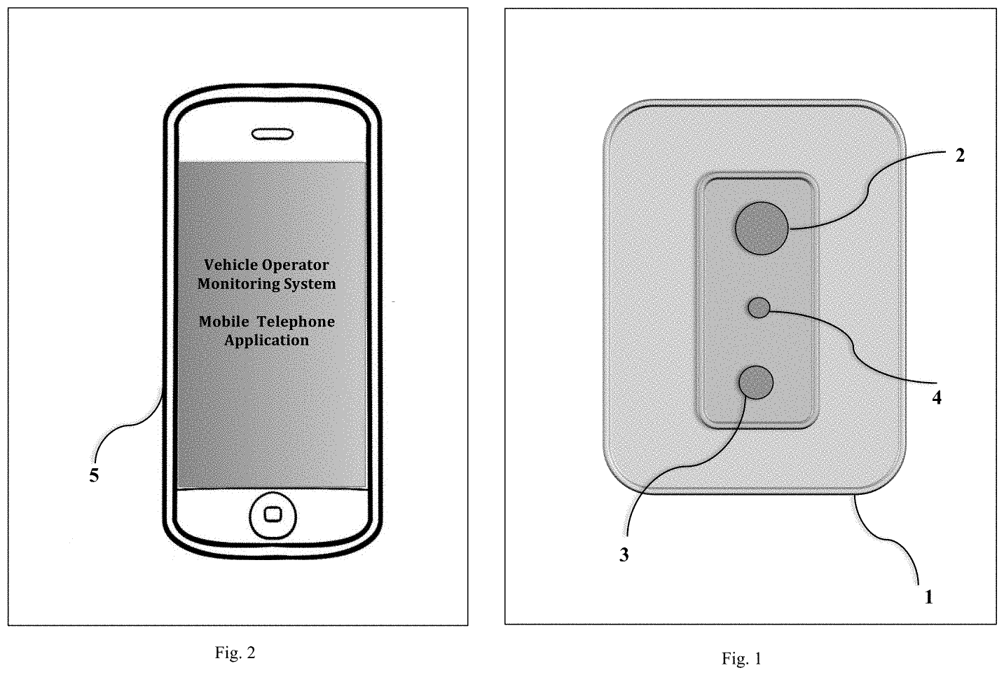

As illustrated in FIG. 1, the present invention is a vehicle operator monitoring system 1, providing two (2) cameras employing a normal and infrared camera lenses 2 and 3. As well, the vehicle operator monitoring system also includes an audio recording function 4. In conjunction with the System's mobile telephone application, as depicted under FIG. 2, the present invention is capable of displaying, recording, and storing the driving patterns of vehicle operators in the visual range of the cameras.

Using the mobile telephone application, an equipped vehicle operator will be capable to either store or transmit any video/audio sequence of adjacent unsafe vehicle operators in the visual range of the cameras. The mobile telephone application registers the GPS location of each video/audio sequence, and can transmit the video/audio sequences via text message or e-mail.

The mobile telephone application FIG. 2 also provides the function to transmit the video/audio sequences to a Cloud-based service for long-term storage, and/or to have the Cloud service e-mail a hyperlink to traffic law enforcement to permit downloading of the video/audio sequences.

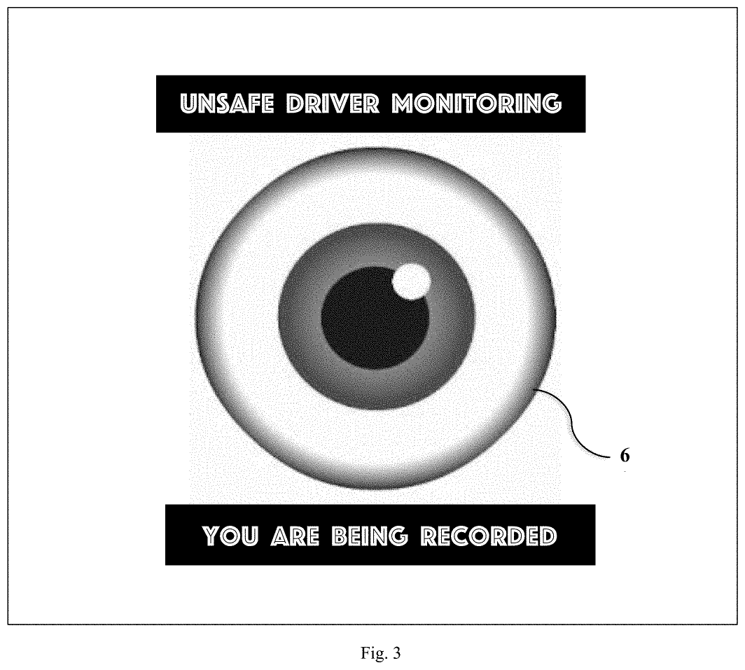

As depicted in FIG. 3, this inventions incorporates the overt use of vehicle decals, one (1) front facing, and one (1) rear facing, to contribute to the deterrence of unsafe vehicle operation. Specifically, with conspicuous placement of the vehicle decals, adjacent vehicle operators are notified that any unsafe driving is being recorded; ideally and preemptively eliminating the likelihood of unsafe driving within the visual range of this invention.

1. A System for recording, storing, and distributing video/audio sequences which comprises of:
two (2) WI-FI equipped, normal and infrared capable cameras mounted to vehicle; one (1) forward facing, one (1) rear facing;
cameras capable of capturing video/audio sequences of adjacent drivers within its field of view;
two (2) conspicuous vehicle decals; one (1) forward facing, one (1) rear facing;
a mobile telephone application to receive, record, store, and distribute the video/audio sequences.

3. Customer maintains all legal ownership and rights of the video/audio sequences;

4. Mobile telephone application maintains video/audio sequences in Customer's smart phone;

3. Using mobile telephone application the video/audio sequences can be forwarded to System's cloud services via text or e-mail for long-term storage.

4. Customers have option to forward the video/audio sequences to anyone via text, email.

5. Customers have option to request System's cloud services to forward video/audio sequences to local traffic law enforcement.

8. Mobile telephone application records the time, date, and global positioning system (GPS) location of the video/audio sequences.

9. The System's cloud services will forward an e-mail to the traffic law enforcement with jurisdiction based on the video/audio sequences' GPS location.

10. The e-mail forwarded to traffic law enforcement will include a download link to the System's cloud storage of the Customer's video/audio sequence.
